(19) United States
(12) Patent Application Publication
(10) Pub. No.: US 2010/0243574 A1
(43) Pub. Date: Sep. 30, 2010

(54) SEPARATOR COLUMN, SEPARATOR SYSTEM, METHOD OF FRACTIONATING MAGNETIC PARTICLES, METHOD OF MANUFACTURING A SEPARATOR COLUMN AND USE OF A SEPARATOR COLUMN

(75) Inventors: Denis Markov, Veldhoven (NL); Hans Marc Bert Boeve, Hechtel-eksel (BE); Bernhard Gleich, Hamburg (DE); Juergen Weizenecker, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/739,177

(22) PCT Filed: Oct. 24, 2008
(86) PCT No.: PCT/IB08/54393

§ 371 Date: Jun. 8, 2010

(30) Foreign Application Priority Data
Oct. 29, 2007 (EP) 07119469.0

(51) Int. Cl. B03C 1/033; B03C 1/025

(52) U.S. Cl. 210/695; 210/222

(57) ABSTRACT

A separator system with a separator column and a method of fractionating magnetic particles, preferably using field-flow fractionation is proposed, which allows for more effective fractionation of magnetic particles with respect to their dynamic magnetic response in a wide frequency and amplitude range of an applied magnetic field, in particular relevant for magnetic particle imaging (MPI).

The present invention relates to a separator column comprising a fluid conducting channel. Furthermore, the invention relates to a method of fractionating magnetic particles in a fluid flowing through a fluid conducting channel of a separator column and to uses of the separator column.

A method of magnetic particle imaging is known from German patent application DE 101 51 778 A1. In the case of the method described in that publication, first a magnetic field having a spatial distribution of the magnetic field strength is generated such that a first sub-zone having a relatively low magnetic field strength and a second sub-zone having a relatively high magnetic field strength are formed in the examination zone. The position in space of the sub-zones in the examination zone is then shifted, so that the magnetization of the particles in the examination zone changes locally. Signals are recorded which are dependent on the magnetization in the examination zone, which magnetization has been influenced by the shift in the position in space of the sub-zones, and information concerning the spatial distribution of the magnetic particles in the examination zone is extracted from these signals, so that an image of the examination zone can be formed. Such an arrangement and such a method have the advantage that it can be used to examine arbitrary examination objects—e. g. human bodies—in a non-destructive manner and without causing any damage and with a high spatial resolution, both close to the surface and remote from the surface of the examination object.

The performance of the known method depends strongly on the performance of the tracer material, i.e. the material of the magnetic particles. There is always the need to increase the signal to noise ratio of known arrangements in order to improve the resolution and the application of such a method to further applications.

Magnetic particles can be fractionated with regard to their dynamic magnetic response onto an oscillating magnetic field by means of high gradient magnetic separation (HGMS). HGMS makes use of a matrix material, for example soft iron or ferrite microspheres, for “passive” local amplification of magnetic field at the surface of the microspheres inside a separation column. Thus induced field gradients result in capture of magnetic particles drawn through the separation column, at the surface of the microspheres. A disadvantages of HGMS is the passive matrix of a separator column. It induces field gradients inside the column that are driven by an external AC field generated by the use of a coil. High frequency operation above 25 kHz and field strength of 10 mT requires sophisticated current amplification. Microspheres of ferrite or soft iron remagnetized at high frequency generate heat in the separation volume of the column. This affects separation results and makes cooling necessary. Another disadvantage is the randomly defined matrix in the separator column, which results in unpredictable particle trajectories due to the respectively distibuted field. Therefore, particles of interest are not completely captured within the column but rather delayed with respect to the unaffected particles.

It is therefore an objective of the present invention to provide a separator column, which allows for separation of improved magnetic particles, in particular for an application in magnetic particle imaging (MPI).

The above objective is achieved by a first embodiment of a separator column comprising a fluid conducting channel and at least one current wire, the current wire being arranged in the fluid conducting channel in such a way that magnetic particles in the fluid conducting channel are influenceable by a gradient magnetic field. It is an advantage of the separator column according to the invention that no matrix material is necessary inside the fluid conducting channel. The one or more current wires may advantageously be utilized in applying the gradient magnetic field. For example, the gradient magnetic field is generated by an external electromagnetic field, the current wire advantageously influencing and/or amplifying the gradient magnetic field. It is advantageously possible to obtain magnetic particles having a comparably sharp distribution of the strength of the anisotropy of their magnetization, thereby increasing the signal to noise ratio when used in the context of magnetic particle imaging (MPI) techniques. Generally, in the context of magnetic particle imaging, it is preferred to use larger particles as they potentially have a larger possible magnetization which in turn can lead to a higher signal-to-noise ratio at the detection stage. Nevertheless, the size of the magnetic particles is limited because particle remagnetization rate drops down exponentially with magnetic core volume of a nanoparticle. With the possibility to precisely separate magnetic particles having a defined strength of anisotropy of their magnetization, it is possible to optimize magnetic nanoparticles with respect to their size and anisotropy, resulting in improved MPI signal to noise ratio.

A gradient magnetic field according to the invention is a magnetic field that comprises a magnetic field gradient for applying a separation force on the magnetic particles. Thereby, an efficient separation of magnetic particles depending upon the strength of anisotropy of their magnetization is advantageously possible.

The above objective is as well achieved by a second embodiment of a separator column comprising a fluid conducting channel and at least one current wire for influencing magnetic particles in the fluid conducting channel by a gradient magnetic field, the fluid conducting channel being arranged at least partially in or on a substrate material. The fluid conducting channel may advantageously be manufactured as a capillary in a reproducible manner and with a high level of regularity of the cross section along the length of the fluid conducting channel. The fractionation efficiency of the separator column is thus advantageously enhanced. Substrates that may advantageously be used are preferably isolating substrates, such as glass, silicium, Teflon or other suitable plastic material. Advantageously, standard lithography techniques may be used for manufacturing the separator column in a reproducible and low-cost manner. According to the invention it is preferred that the fluid conducting channel of the the first embodiment is arranged on or in a substrate.

According to the second embodiment of the invention, it is preferred that the at least one current wire is arranged at least partially in or on the substrate material, as well. This advantageously allows a high level of regularity of the spacing between the current wire or wires and a wall of the fluid conducting channel, and further, if applicable, a high level of regularity of the spacing between the respective current wires. More preferably, the separator column is a lab-on-chip (LOC) device, also referred to as lab-on-a-chip, a device that integrates (multiple) laboratory functions on a substrate material or chip of only millimeters to a few square centimeters in size and that are capable of handling extremely small fluid volumes down to less than pico liters. A lab-on-chip device is a so-called microelectromechanical system (MEMS).

The following preferred embodiments refer to both the first and second embodiments of the separator column.

The fluid conducting channel of the separator column preferably comprises a channel wall of any suitable geometry, the cross section may, for example by circular, squared or rectangular. Preferably, the cross section of the fluid conducting channel is generally constant over a length of the fluid conducting channel. Advantageously, the fractionation efficiency is improved as the solution layers are retarded differentially according to their distance from the channel wall. The at least one current wire is preferably arranged generally parallel to the channel wall. Furthermore preferably, the at least one current wire is arranged spaced from the channel wall. Advantageously, the current wire or wires according to this embodiment, serve as an additional “wall” for the flow in the fluid conducting channel, so that a generally parabolic flow profile is formed around the current wire or wires. Alternatively or additionally, at least one current wire is arranged adjacent to the channel wall. For current wires arranged inside the fluid conducting channel, the current wires preferably comprise an isolating cover, for advantageous isolation from the fluid. Furthermore preferred, the at least one current wire is arranged inside the channel wall. This embodiment is advantageous in production and no isolation is necessary. However, the skilled artisan will acknowledge, that for a plurality of current wires any combination of the described arrangements is possible.

According to a preferred embodiment, the number of current wires arranged in the fluid conducting channel and/or in or on the substrate material is in a range between one and about 100. A cross-section of each current wire is between about 20 μm² and about 8000 μm², preferably between about 800 μm² and about 800 μm², more preferably about 300 μm². A diameter or width of the fluid conducting channel is in a range from about 10 micrometer to about 1000 micrometer, in particular the cross sectional dimensions of the fluid conducting channel depend on the number of current wires applied. The skilled artisan will acknowledge that a larger diameter or width of the fluid conducting channel allows the accommodation of a higher number of current wires. However, advantageously, a larger diameter or width of the fluid conducting channel will result in higher throughput of the separator column.

A length of the fluid conducting channel is preferably up to about 3 meter, preferably about 0.5 meter to about 2 meter. In a preferred embodiment, the fluid conducting channel is not straight, but comprises at least one bending, which advantageously improves handling of the separator column. Particularly preferable, the fluid conducting channel is convoluted. As a result, the separator column may advantageously have comparably compact dimensions, despite the extremely high aspect ratio of the fluid conducting channel length to its cross sectional dimensions.

The invention further refers to a separator system comprising a separator column according to the invention, wherein the at least one current wire is connected to a current source, such that the gradient magnetic field is generated by the current wire. The magnetic particles are advantageously separated depending upon the strength of the anisotropy of their magnetization. This allows for the generation of magnetic particles having a well defined strength of the anisotropy of their magnetization, i.e. a comparably sharply delimited distribution of this property. This magnetic material may be covered, for example, by means of a coating layer which improves colloidal stability and protects the particle against chemically and/or physically aggressive environments, e.g. acids. The magnetic particles to be fractionated are magnetically anisotropic, i.e. they have an anisotropy of their magnetization. Such an anisotropy can e.g. be provided by means of shape anisotropy and/or by means of crystal anisotropy and/or by means of induced anisotropy and/or by means of surface anisotropy.

More preferably, the magnetic field is varying in time. In a particularly preferable embodiment, the current source is an alternate current (AC) source, such that the generated gradient magnetic field is oscillating. The magnetic particles are remagnetized by the oscillating high gradient magnetic field. Particles with different magnetic anisotropy yield different remagnetization times which advantageously allows a discrimination of the particles depending upon their magnetic anisotropy. Advantageously, the above described problems of HGMS are overcome by using high frequency magnetic Field-Flow Fractionation (FFF). Field-flow fractionation (FFF), in the sense of the present invention, is meant to be a methodology of separation in which solution zones are layered within the fluid conducting channel by the application of the gradient magnetic field. The layers of the solution are displaced by the flow through the fluid conducting channel, wherein the flow is slowest near a wall of the channel. Hence, the layers of the solution are retarded differentially according to their distance from the wall. Advantageously, the separator column of the separator system allows the application of the magnetic FFF principle and is selective to the dynamics of nanoparticle remagnetization. By an AC magnetic field/field gradient generated by the current wire or wires in the fluid conducting channel the advantages of both HGMS and magnetic FFF are combined. It allows AC field gradient generation, in particular at high frequency, over widespread intervals of field strength and thus for fractionation of magnetic particles of different magnetic core sizes.

In a preferred embodiment of the separator system, the current source provides a current in a range of about 0.01 A to about 2 A per current wire, preferably in a range of about 0.1 A to about 0.5 A. Furthermore preferably, the magnetic field strength is in a range of about 1 mT (millitesla) to about 20 mT, preferably below about 10 mT. Furthermore preferably, the magnetic field strength gradient is in a range of about 10 T/m to about 3000 T/m, preferably in a range of about 50 T/m to about 1000 T/m. The person skilled in the art will recognise that, in order to obtain the particular magnetic field strength, the value specified as the magnetic field strength in tesla in the context of the present invention, in each case has to be divided by the magnetic field constant μ₀, as tesla is the unit of the magnetic flux density.

According to a further preferred embodiment of the separator system, the separator column comprises a plurality of current wires, a direction of flow of a current applied to at least two of the current wires is opposite to each other. Regarding alternate current applied to the current wires, an alternate current (AC) applied to at least two of the current wires preferably being phase shifted with respect to each other. It is an advantage of the embodiment that the resulting magnetic field outside the separator column is reduced, due to superposition of the single magnetic fields generated by each current wire. The desired gradient magnetic field between the current wires, however, is still appropriate for fractionating the magnetic particles. A skilled artisan will recognize that a phase shift of 180° will be most advantageous for two current wires. Regarding a higher number of current wires, for example up to 100 current wires, generally each current wire could be fed with an else phase-shifted alternate current with respect to the rest of the wires.

In a further preferred embodiment, a frequency of the alternate current is adjustable, in particular depending on a property of the magnetic particles to be separated, preferably their magnetic anisotropy. This embodiment advantageously allows effective fractionation of magnetic nanoparticles based on dynamic magnetic response. It effectively addresses nanoparticles with magnetic anisotropies, for example below 2000 J/m³, for 30 nm magnetic core diameter, by AC field generation in the MHz range. The fractionation resolution/efficiency is advantageously improved. The strength of anisotropy of the magnetization of magnetic particles signifies the exterior magnetic field (exterior relative to the magnetic particle) that is necessary in order to change significantly the magnetization of the magnetic particle. Fractions of particles with a more relevant anisotropy range will further advantageously improve the MPI signal, which is sensitive to the remagnetization rate of the magnetic tracer. The frequency of the alternate current is preferably adjustable in a range of about 5 kilohertz (kHz) to about 10 megahertz (MHz). Thereby, it is advantageously possible to adapt the separator system to a plurality of different magnetic particles, e.g. of different size, anisotropy and/or of different environment of the magnetic particles.

According to a further preferred embodiment, the separator system comprises a pump connected to the fluid conducting channel to provide a flow of the fluid through the fluid conducting channel. Preferably, a buffer is pumped through the separator column, the kind of buffer depending on the solution carrying the magnetic particles, which is also referred to as ferrofluid. Generally, preferably the same buffer is used as the one, the ferrofluid is based on and/or stable in. For example, demi water may be used for a water-based ferrofluid. However, salt and different stabilizers may be added to water for preparation of the buffer, but also different organic solvent may be used instead of water, for example hexane.

According to a further preferred embodiment, the separator system comprises an injection valve connected to the fluid conducting channel for injecting the magnetic particles, in particular for injecting the ferrofluid. Furthermore preferred, the separator system comprises a selection valve to isolate a preferred fraction of the fluid flow. Furthermore preferred, the separator system comprises a detector for screening the fluid flow after passage of the fluid conducting channel.

According to a further preferred embodiment, the separator system comprises one or more components, the components comprising at least one of a current source, a pump, an injection valve, a separation valve, a detector and a fluid reservoir, the separator system being a lab-on-chip (LOC) device, also referred to as lab-on-a-chip or as “Micro Total Analysis System” (μTAS), which means a device that integrates (multiple) laboratory functions on a substrate material or chip of only millimeters to a few square centimeters in size. In the sense of the invention, the separator column comprises at least the fluid conducting channel and the one or more current wires, whereas the separator system comprises at least one separator column and preferably one or more of the above mentioned components.

The invention further relates to a method of fractionating magnetic particles in a fluid flowing through a fluid conducting channel of a separator column, the method comprising the steps of providing at least one current wire in the fluid conducting channel and influencing the magnetic particles in the fluid by generating a gradient magnetic field. The magnetic field may, for example, be generated by external magnets. According to a preferred embodiment, the magnetic field is generated by applying a current to the at least one current wire. More preferably, the magnetic field is varied in time. It is an advantage, that the problems of the HGMS method can be overcome by using high frequency magnetic Field-Flow Fractionation (FFF).

According to a preferred embodiment, a plurality of droplets of a fluid comprising magnetic particles, in particular a ferrofluid, is injected into the fluid conducting channel sequentially. It is an advantage of the embodiment, that the plurality of droplets flow through the fluid conducting channel at the same time in spaced relation to each other.

According to another preferred embodiment, a plurality of droplets of a fluid comprising magnetic particles is injected into fluid conducting channels of a plurality of separator columns in parallel. The throughput is advantageously increased, in particular at the beginning of a separation process, where large quantities of starting material are processed.

According to yet another preferred embodiment, the method further comprises a relaxation step, wherein the fluid flow is temporarily stopped. After the ferrofluid droplet is injected into the fluid conducting channel and the field is applied, some time must evolve before the magnetic particles relax to a quasi-equilibrium distribution around the wires, which is advantageously possible with a shorter fluid conduction channel or with increased average flow speed if the flow is stopped temporarily.

According to yet another preferred embodiment, a flow speed of the fluid flow is adjusted, depending on the preferred fraction of magnetic particles to separate.

According to yet another preferred embodiment, the method further comprises an up concentration step, wherein a concentration of preferred magnetic particles in a separated fraction of fluid is increased. A concentration of the magnetic particles in a fluid is thus advantageously increased. The skilled artisan recognizes that the magnetic particles are dispersed in a certain amount of fluid, in particular in a liquid fluid. For concentration, different techniques can be utilized such as, for example, vacuum evaporation. In a preferred embodiment, the concentration step comprises repeatedly circulating the fluid through any kind of separator column and particularly by repeated circulation through the fluid conducting channel.

The invention further relates to a method of manufacturing a separator column, comprising the steps of providing a fluid conducting channel in or on a substrate material and providing at least one current wire in the fluid conducting channel. The method of manufacturing allows advantageously a production of the fluid conducting channel as a capillary in a reproducible manner and with a high level of regularity of the cross section along the length of the fluid conducting channel, and a high level of regularity of the spacing between the current wire or wires and a wall of the fluid conducting channel, and further, if applicable, a high level of regularity of the spacing between the respective current wires.

Preferably, at least the fluid conducting channel and the at least one current wire are produced as a lab-on-chip (LOC) device. More preferable, further components of the separator column are integrated in the lab-on-chip device, particularly at least one of a current source, a pump, an injection valve, a separation valve, a detector and a fluid reservoir. Hence, the complete separator column may advantageously be integrated in the lab-on chip device. Advantageously, standard lab-on-chip production techniques may be used for manufacturing the separator column in a reproducible and low-cost manner. The basis for most LOC fabrication processes is lithography, which is most adequate for semiconductor fabrication. Additionally, glass-, ceramics- and metal etching, deposition and bonding, PDMS (polydimethylsiloxane) processing, e.g. soft lithography, thick-film- and stereolithography as well as fast replication methods via electroplating, injection molding and embossing may be used. Generally speaking, LOC manufacturing refers to lithography-based microsystem technology, as well as nano technology and precision engineering.

The invention further relates to a use of a separator column according to the invention for fractionation of magnetic nanoparticles based on a magnetic response of the nanoparticles.

The invention further relates to a use of a separator column according to the invention for obtaining tracer material for magnetic particle imaging (MPI) applications.

The invention further relates to a use of a separator column according to the present invention for obtaining magnetic particle assays to be used in magnetic biosensors.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

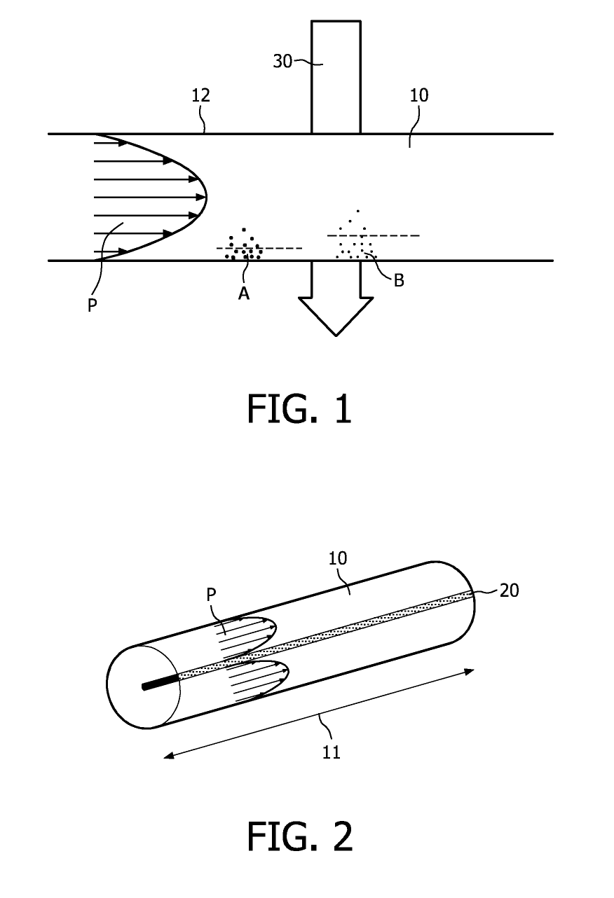

FIG. 1 illustrates schematically the principle of Field-flow fractionation.

FIG. 2 illustrate schematically a fluid conducting channel of a first embodiment of a separator column according to the invention.

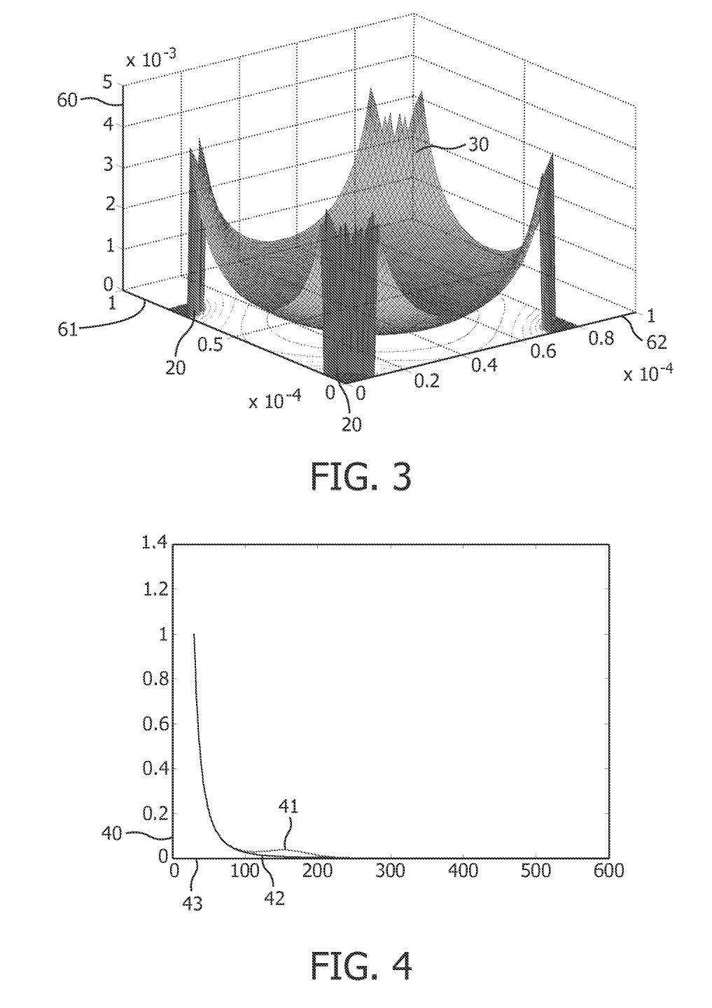

FIG. 3 illustrates a preferred embodiment of the separator column by a profile of a gradient magnetic field in a three dimensional diagram.

FIGS. 4, 5 and 6 illustrate the time response of relative magnetic particle concentrations in diagrams.

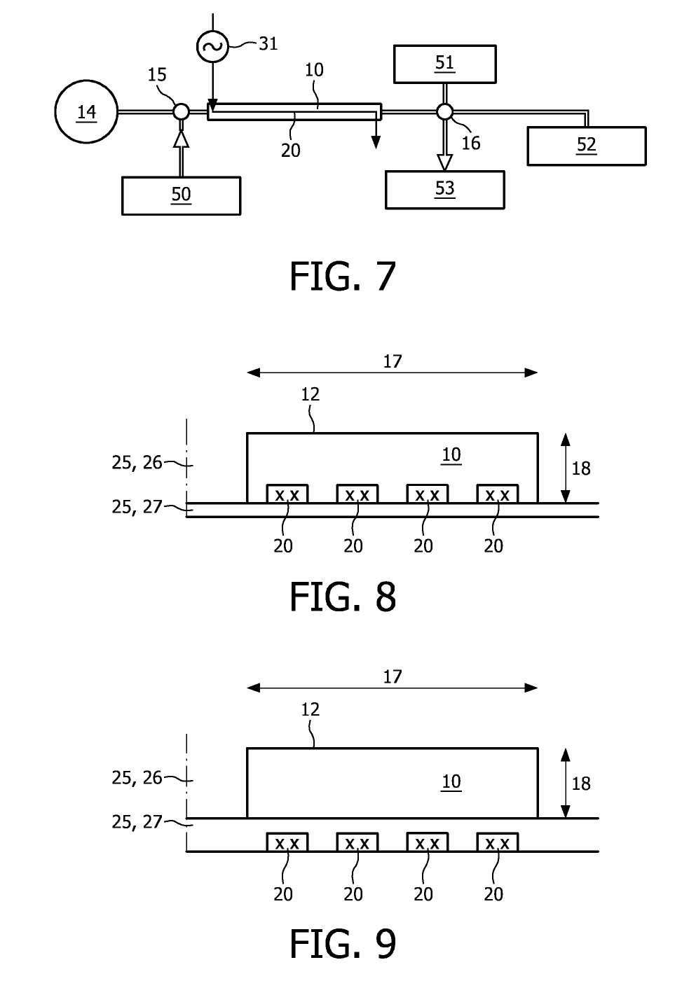

FIG. 7 illustrates schematically a preferred embodiment of a separator system according to the present invention.

FIGS. 8 and 9 illustrate schematically a fluid conducting channel of a second embodiment of a separator column according to the invention.

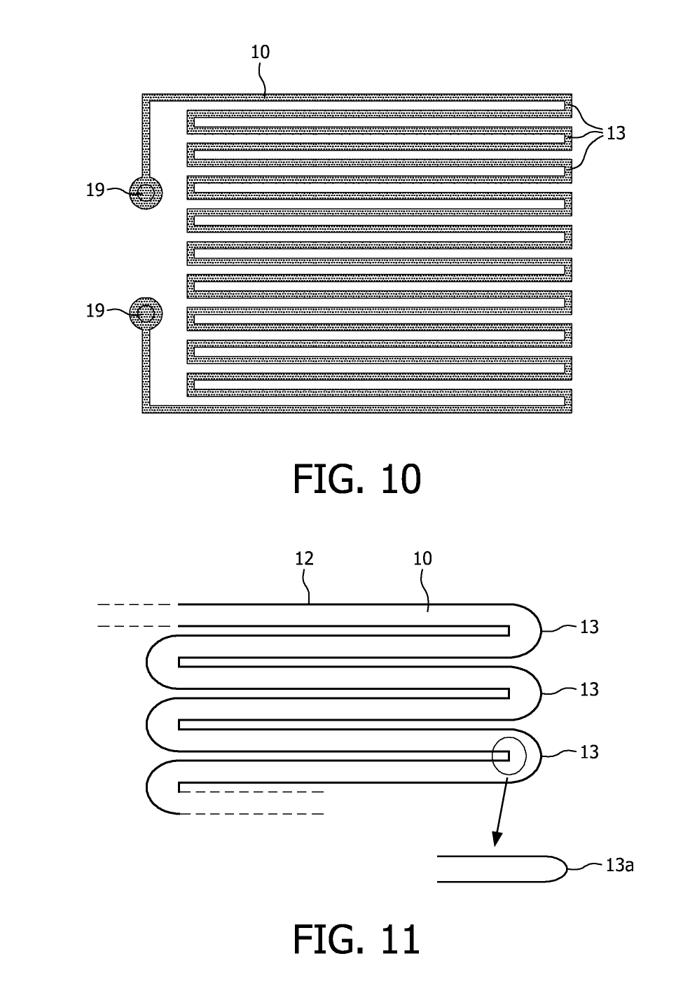

FIG. 10 illustrates schematically a preferred embodiment of the fluid conducting channel according to one of FIG. 2, 8 or 9.

FIG. 11 schematically illustrates the embodiment of FIG. 10 in detail.

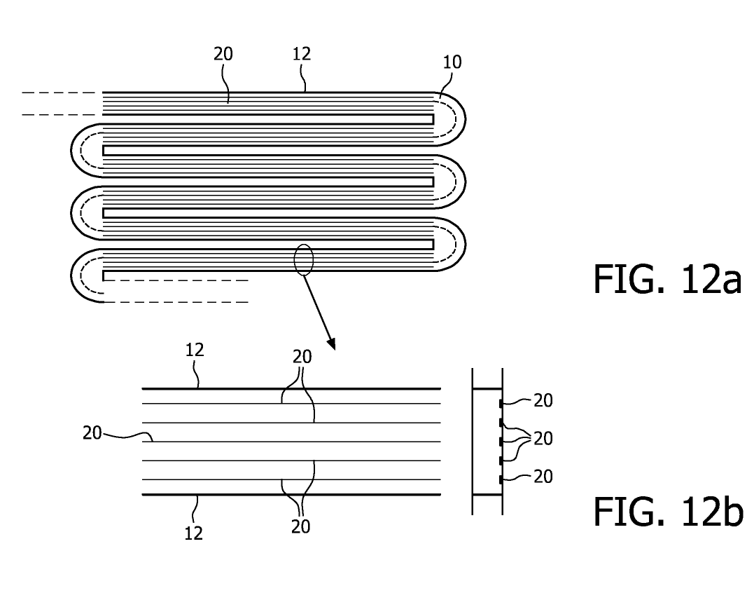

FIGS. 12a and 12b schematically illustrate the embodiment of FIG. 10 in more detail.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described of illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the present description and claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

In FIG. 1, the principle of Field-flow fractionation (FFF) is illustrated with respect to a fluid conducting channel 10 with a channel wall 12, wherein a fluid is flowing. A parabolic flow profile P illustrates the flow speed inside the fluid conducting channel 10. The flow speed near the channel wall 12 is comparably slower than in more central regions of the fluid conducting channel 10, which is illustrated by arrows, the lengths of which represent the respective flow speed. FFF is a broad methodology of separation in which zones of the fluid are initially layered at the side of the fluid conducting channel 10 by the application of an external field 30. Layer thicknesses differ for each kind of fluid, depending on the interaction between the field 30 and the particles A, B in the fluid, which is illustrated by dashed lines. For example, a certain average percentage, say 90% of the magnetic particles A, B will be located in the layer between the dashed line and the wall of the fluid conducting channel 10. The fluid is then displaced by the longitudinal flow through the fluid conducting channel 10. Since the flow speed is slowest near the channel wall 12, the layers comprising particles A, B are retarded differentially according to their distance from the channel wall 12.

In FIG. 2, a fluid conducting channel 10 of a first embodiment of a separator column according to the invention is depicted schematically. The separator column is based on the FFF principle and thus is advantageously selective to the dynamics of nanoparticle remagnetization. An oscillating or alternate current (AC) magnetic field 30 is generated by the current wire 20 inserted into the fluid conducting channel 10, which has a length 11 of, for example, one meter. This approach combines advantages of both HGMS and magnetic FFF.

It is an advantage that the current wire 20 serves as a wall for the fluid flow in the fluid conducting channel 10 as well, so that the parabolic flow profile P is formed around the current wire 20. Pulse-injected into the fluid conducting channel 10, magnetic particles (not depicted) with different dynamic magnetic response onto the field 30 generated by the current wire 20 are displaced by the longitudinal flow as shown in FIG. 1.

In this configuration, the separation of the magnetic particles can be achieved due to a quicker reorientation of the magnetization of such magnetic particles having a defined strength of anisotropy of their magnetization. These magnetic particles A, B (FIG. 1) out of the plurality of magnetic particles are attracted towards the current wire 20, i.e. in the direction of a stronger magnetic field 30, whereas magnetic particles having a different strength of anisotropy of their magnetization need a longer time in order to reverse their magnetization. During this time interval, without having reversed their magnetization, these magnetic particles are repelled by the gradient magnetic field 30.

When the fluid containing the magnetic particles is flowing along the fluid conducting channel 10 in the presence of the gradient AC magnetic field, then the magnetic particles A, B (FIG. 1) having a defined strength of anisotropy of their magnetization are e.g. attracted towards the current wire 20, thereby flowing at a lower velocity than the rest of the magnetic particles. Therefore, a spatial separation of the magnetic particles depending upon the strength of anisotropy of their magnetization is realised. This typically results in difference in the elution times of fractions comprising mainly particles A or B. Thus, collection of the different fractions is preferably performed at different times after injection of the magnetic particles into the fluid conducting channel 10. As a result, the separator column allows for fractionation of magnetic nanoparticles based on dynamic magnetic response. It effectively addresses nanoparticles with magnetic anisotropies, e.g. below 2000 J/m³ for 30 nm magnetic core diameter by AC field generation in the MHz range. A droplet size of the injected fluid comprising magnetic particles is in the order of one micro-liter and above, the droplets are preferably injected in a sequential mode, i.e. droplet-by-droplet. Alternatively, large quantities of starting material may be processed using multiple parallel fluid conducting channels.

It is intended to use one or more current wires 20 inside of the fluid conducting channel. Multiple parallel current wires 20 will allow for wider fluid conducting channels, so that the through-put of fluid may advantageously be increased.

A preferred embodiment of the separator column, comprising a fluid conducting channel 10 with four current wires 20 will be described with respect to FIG. 3, which shows a profile of the gradient magnetic field 30 generated by the four current wires 20, in a three dimensional diagram. The dimensions of a cross section of the fluid conducting channel 10 are shown on the axes 61, 62 in 10⁻⁴ m. The axis 60 represents the field strength of the magnetic field 30 in millitesla (mT). The current wires 20 with a diameter of approximately 20 μm are placed within the fluid conducting channel 10 at a distance of 60 μm from each other and parallel to the channel walls. A current through each of the current wires 20 is, for example, 0.25 A at 25 kHz, in order to generate the depicted magnetic field 30.

In FIGS. 4, 5 and 6 respectively, a relative magnetic particle concentration is illustrated on axes of abscissae 40 versus the time, which the fluid takes from injection into the fluid conducting channel 10 to elution from it, shown on ordinate axis 43, in seconds. The fluid conducting channel is, for example, about 1 m long and has a diameter of about 250 micrometer. A pulsed injection of the fluid comprising magnetic particles, also referred to as ferrofluid is to be made into the multiple-parabolic flow of a buffer fluid at one end of the fluid conducting channel 10. If no magnetic field is applied the elution profile represented by a relative magnetic particle concentration measured at another end of the fluid conducting channel versus time, will show gradual decay after some idle time, as depicted in the diagram of FIG. 4 in curve 42. However, the elution profile will be modified upon the application of the gradient magnetic field, since those particles that are fast enough to be effectively remagnetized at, for example, 25 kHz will flow within the slow layers in the proximity of the current wires 20. The curve 41 in FIG. 4 corresponds to the elution of 30 nm Fe oxide particles with a magnetic anisotropy of K=3000 J/m³. Thus, size-monodispersed magnetic particles are expected to have discrete, different flow-through times dependent on their anisotropies: the smaller the anisotropy the longer the flow-through time. The relative magnetic particle concentration is measureable by a detector (cf. FIG. 7), for example, a conventional UV-VIS detector for particle size, a susceptometer for magnetic size of the particles, or an MPS (Magnetic Particle Spectrometer) based detector sensitive to MPI performance of particles in the flow.

Under the above described conditions, separation of the K=3000 J/m³ particles out of the rest of the ferrofluid will take 2 to 3 minutes. After the ferrofluid droplet is injected into the fluid conducting channel and the gradient magnetic field is applied, some time must evolve before the magnetic particles relax to a quasi-equilibrium distribution around the current wires. Thus, ferrofluid injection is advantageously followed by an additional relaxation step, wherein the flow is to be stopped, for example for about 7 seconds in the current example.

A person skilled in the art will recognise that the flow-through time is primarily related to the average flow speed over the length of the fluid conducting channel. This is one of a number of different parameters, which may advantageously be optimised for fractionation efficiency, i.e. to have an optimum yield in terms of magnetic properties of the magnetic particles for MPI. Fractionation of magnetic particles with different dynamic magnetic response (magnetic anisotropy) may, for example, be carried out by varying a collection time, the current frequency and/or current amplitude and/or the flow speed. Compared to HGMS, the frequency of the AC magnetic field can advantageously be increased up to a MHz range and thus particles with low magnetic anisotropy (e.g.<2000 J/m³) can be better addressed and fractionated with a high efficiency.

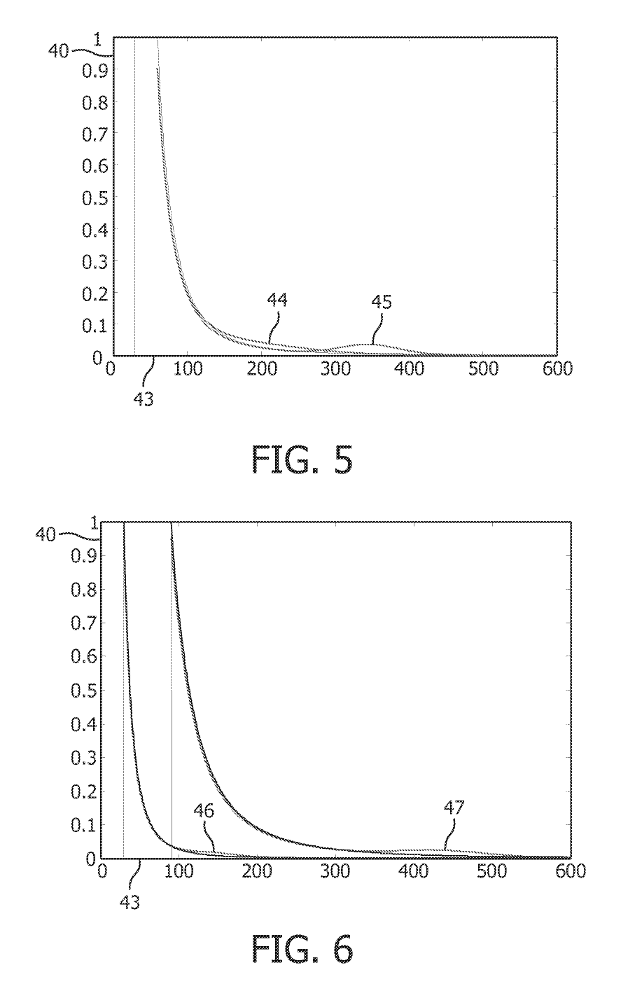

Two different elution profiles are shown in the diagram of FIG. 5, which correspond to particles with a magnetic anisotropy of K=1900 J/m³ in curve 44 and particles with a magnetic anisotropy of K=1500 J/m³ in curve 45, respectively.

In FIG. 6, elution profiles of 30 nm nanoparticles with anisotropy of 1800 J/m³ fractionated at 2 MHz are shown in a diagram. It has been found that a three-fold reduction in flow speed, illustrated in curve 47 versus curve 46, results in three-fold improvement in fractionation efficiency.

In FIG. 7, a preferred embodiment of a separator system according to the invention is schematically depicted. The separator system comprises a pump 14 to drive a constant buffer flow through the fluid conducting channel 10. The fluid conducting channel 10 may, for example be made of glass, fused silica, PEEK (polyetheretherketones, also referred to as polyketones) or Radel-R (polyphenylsulfone, PPSU). Inside the fluid conducting channel 10, one or more current wires 20 are arranged, connected to a high-frequency current source 31. An injection valve 15 is used for injection for the ferrofluid 50, preferably automatically. A selection valve 16 isolates the preferred fraction 53 of the magnetic particles from the fluid flow. The remaining fluid is conducted to a regeneration means 52. A detector 51 is used for for elution profile screening. This is, for example, a conventional ultraviolet-visible spectroscopy or ultraviolet-visible spectrophotometry (UV/VIS) detector for particle size, a susceptometer for magnetic size, or a MPS (Magnetic Particle Spectrometer) based detector sensitive to MPI performance of particles in the flow. A detector signal may advantageously be used as a feed-back for the injection valve 15 and/or the selection valve 16. The depicted separator column is preferably a lab-on-chip (LOC) device at least one of the fluid conducting channel 10, the current wire 20, current source 31, pump 14, injection valve 15, separation valve 16, detector 51 and fluid reservoirs 50, 52, 53 being integrated on the LOC.

The throughput of the separator column basically depends on a dimensioning of the fluid conducting channel 10. A volume of the injected ferrofluid at a time (i.e. per droplet) will, for example, scale with the total volume of the fluid conducting channel 10. Droplet size in the order of micro-liter and above is preferred, to be operated in a sequential mode, i.e. droplet-by-droplet. Process time can thus advantageously be decreased since multiple droplets can be in the fluid conducting channel 10 at the same time, however spatially displaced. Large quantities of starting material may advantageously be processed by parallel processing, preferably using multiple parallel fluid conducting channels 10.

In FIGS. 8 and 9, cross-sections of a fluid conducting channel 10 with rectangular channel walls 12 are schematically depicted. According to the invention, this second embodiment of the fluid conducting channel 10 is arranged at least partially in or on a substrate material 25, indicatedly shown. The fluid conducting channel may advantageously be manufactured as a capillary in a reproducible manner and with a high level of regularity of the cross section along the length of the fluid conducting channel 10. The fractionation efficiency of the separator column is thus advantageously enhanced. Substrates that may advantageously be used are preferably isolating substrates, such as glass, silicium, Teflon or other suitable plastic material. Advantageously, standard lithography techniques may be used for manufacturing the separator column in a reproducible and low-cost manner. The width 17 of the fluid conducting channel 10 is greater than its height 18, giving the fluid conducting channel 10 a planar arrangement. In FIG. 8, an embodiment is shown, wherein four current wires 20 are arranged adjacent the channel wall 12, i.e inside the fluid conducting channel 10. The current wires 20 preferably are coated by an isolating material (not depicted). The current wires 20 of the depicted embodiment are arranged on a first layer 27 of the substrate material 25, which is assembled to a second layer 26 of the substrate material 25, wherein the fluid conducting channel 10 is provided as a groove.

According to the embodiment of FIG. 9, the fluid conducting channel 10 is provided as a groove in a second layer 26 of the substrate material 25, as well. The first layer 27 of the substrate material 25 forms a covering wall of the fluid conducting channel 10, the current wires 20 being arranged inside the covering wall, however without contact to the fluid flowing inside the fluid conducting channel 10. Thus, advantageously, an isolating cover for the current wires 20 is not necessary.

In FIG. 10, an embodiment of the fluid conducting channel 10 according to one of FIG. 8 or 9 is schematically depicted, the fluid conducting channel 10 comprising a multitude of bendings 13, only part of which are exemplarily provided with reference numbers. The convoluted or meandering arrangement of the fluid conducting channel 10 is advantageous, as the fluid conducting channel 10 with a length of about 2 meter may be arranged on or in the substrate (25, cf. FIGS. 8, 9) of only a few square centimeter area. Connections 19 represent an inlet and an outlet of the fluid conducting channel 10. These fluidic connections 19 are preferably realized by attaching capillaries into the substrate 25.

In FIGS. 11, 12a and 12b, the convoluted structure of the channel wall 12 of the fluid conducting channel 10 is depicted in more detail. A detail in FIG. 11 is encircled and depicted at a larger scale, wherein a rounded inner bending 13a providing a constant cross section of the fluid conducting channel 10 is shown.

In FIG. 12a, the embodiment of FIG. 11 is shown with current wires 20 in the fluid conducting channel 10. A detail in FIG. 12a is encircled and depicted at a larger scale in FIG. 12b, showing five current wires 20 running between the channel walls 12. At the right, a cross section of the larger scale detail is depicted, wherein the five current wires 20 are arranged adjacent the longer channel wall 12.

A typical fluid conducting channel 10 length is in the order of tens of centimetres to metres, in particular 0.5 m to 2 m for iron oxide MPI nanoparticles, and it varies on of the particular magnetic material and size of particles to be fractionated. The fluid conducting channel 10 is preferably manufactured in the form of a meander to minimize the total surface that is required. The fluid conducting channel 10 comprises typically dimensions of approximately 100 μm to a few mm laterally (17, cf. FIGS. 8, 9) and approximately 10 to 500 μm vertically (18, cf. FIGS. 8, 9). Typical values would be 1 mm laterally and 60 μm vertically. Such a fluid conducting channel 10 can be manufactured between two substrate layers 26, 27 (cf. FIGS. 8, 9) using standard lab-on-chip techniques, such as the use of high-aspect ratio resists, e.g. SU-8, a commonly used negative photoresist. SU-8 is a very viscous polymer that may advantageously be spun or spread over a thickness ranging from 1 micrometer up to 2 millimeters and still be processed with standard mask aligner. It can be used to pattern high aspect ratio structures. An up-scaled version of the fluid conducting channel 10 may further use other known techniques for channel definition. One or more current wires 20 are matched to the fluid conducting channel 10. The current wires 20 can be inside the fluid conducting channel 10 (FIG. 8), i.e. on the inner channel wall 12, or buried into the channel wall (FIG. 9). In the former, a passivation layer can be used to isolate the fluid from the current wires 20. Dimensions for the current wires 20 are in the order of μm in height and width to tens of μm, in particular for width only. For current levels per current wire 20 in the order of 10 mA to 1 A, depending on the wire dimensions, preferably around 100 mA to 200 mA, such a current wire 20 will generate high magnetic field gradients, in the order of 100 T/m and higher, in combination with low magnetic fields, i.e. below 10 mT. The distance between the current wires 20 should be chosen such that the overall gradient is maximized over the width of the device. Therefore a design aspect is a distance between the current wires 20 that is preferably approximately equal to double the height of the fluid conducting channel 10.

The current wires 20 can be applied on both sides of the fluid conducting channel 10. In this case a symmetrical design with double channel height (18, cf. FIGS. 8, 9) would be preferable.

A number of different layouts can be advantageously implemented, from parallel current wires 20, to more complex parallel—series connections of current wires 20, that allow to tune the impedance of the separator column for high frequency operation, i.e. 100 kHz to 10 MHz range, and to reduce the overall power consumption. The operational window of the separator column is limited due to heat generation. Temperature of the fluid conducting channel 10 is preferably controlled by monitoring the effective resistance of a dedicated resistor structure on the substrate 25. In the case of a number of parallel current wires 20, one of the current wires 20 may advantageously be used as a temperature sensor. Cooling of the separation device during operation by means of natural or forced convection (air or liquid) can be implemented.

1. Separator column comprising a fluid conducting channel (10) and at least one current wire (20), the current wire being arranged in the fluid conducting channel in such a way that magnetic particles (A, B) in the fluid conducting channel are influenceable by a gradient magnetic field (30).

2. Separator column comprising a fluid conducting channel (10) and at least one current wire (20) for influencing magnetic particles (A, B) in the fluid conducting channel by a gradient magnetic field (30), the fluid conducting channel being arranged at least partially in or on a substrate material (25).

3. Separator column according to claim 2, further comprising one or more current wires (20), the separator column being a lab-on-chip (LOC) device.

4. Separator column according to claim 1, wherein the at least one current wire (20) is arranged spaced from a channel wall (12) inside the fluid conducting channel (10) and/or adjacent to the channel wall (12), the at least one current wire preferably comprising an isolating cover.

5. Separator column according to claim 1, wherein the at least one current wire (20) is arranged in a channel wall (12).

6. Separator column according to claim 1, wherein between one and about 100 current wires are arranged in the fluid conducting channel (10) and/or in or on a substrate material (25).

7. Separator column according claim 1, wherein a length (11) of the fluid conducting channel (10) is up to about 3 meter, preferably about 0.5 meter to about 2 meter.

8. Separator column according to claim 1, wherein the fluid conducting channel (10) comprises at least one bending (13), the fluid conducting channel (10) preferably being convoluted.

9. Separator system comprising a separator column according to claim 1, wherein the at least one current wire (20) is connected to a current source (31), such that the gradient magnetic field (30) is generated by the current wire.

10. Separator system according to claim 9, wherein the magnetic field (30) is varying in time.

11. Separator system according to claim 9, wherein the current source (31) is an alternate current (AC) source, such that the generated gradient magnetic field (30) is oscillating.

12. Separator system according to claim 9, wherein the separator column comprises a plurality of current wires (20), a direction of flow of a current applied to at least two of the current wires is opposite to each other.

13. Separator system according to claim 9, wherein the separator column comprises a plurality of current wires (20), an alternate current (AC) applied to at least two of the current wires being phase shifted with respect to each other.

14. Separator system according to claim 9, further comprising one or more components, the components comprising at least one of a current source (31), a pump (14), an injection valve (15), a separation valve (16), a detector (51) and a fluid reservoir (50, 52, 53), the separator system being a lab-on-chip (LOC) device.

15. Method of fractionating magnetic particles in a fluid flowing through a fluid conducting channel (10) of a separator column, comprising the steps of providing at least one current wire (20) in the fluid conducting channel and influencing the magnetic particles in the fluid by generating a gradient magnetic field (30).

16. Method according to claim 15, wherein the magnetic field (30) is generated by applying a current to the at least one current wire (20).

17. Method according to claim 15, wherein the magnetic field (30) is varied in time.

18. Method according to claim 15, further comprising a relaxation step, wherein the fluid flow is temporarily stopped.

19. Method according to claim 15, wherein a flow speed of the fluid flow is adjusted, depending on the preferred fraction of magnetic particles to separate.

20. Method of manufacturing a separator column, comprising the steps of providing a fluid conducting channel (10) in or on a substrate material (25) and providing at least one current wire (20) in the fluid conducting channel.

21. Method according to claim 20, wherein the fluid conducting channel (10) and/or the at least one current wire (20) are produced as a lab-on-chip (LOC) device.

22. Use of a separator column according to claim 1 for fractionation of magnetic nanoparticles based on a magnetic response of the nanoparticles.

23. Use of a separator column according to claim 1 for obtaining tracer material for magnetic particle imaging (MPI) applications and/or for obtaining magnetic particle assays for magnetic biosensor applications.
